(19) United States
(12) Patent Application Publication
(10) Pub. No.: US 2002/0124176 A1
(43) Pub. Date: Sep. 5, 2002

(54) BIOMETRIC IDENTIFICATION MECHANISM THAT PRESERVES THE INTEGRITY OF THE BIOMETRIC INFORMATION

(76) Inventor: MICHAEL EPSTEIN, SPRING VALLEY, NY (US)

Correspondence Address: ALGY TAMOSHUNAS, US PHILIPS CORPORATION, 580 WHITE PLAINS ROAD, TARRYTOWN, NY, 10591

(21) Appl. No.: 09/211,155

(22) Filed: Dec. 14, 1998

(51) Int. Cl. H04L 9/32

(52) U.S. Cl. 713/186; 380/277; 713/168; 713/202

(57) ABSTRACT

The use of biometric information for authentication and access control is facilitated by the use of a token device. The token device contains an encryption of a key that is based on an authorized user's biometric information. The security system communicates with the token device to determine whether the current user of the token is the authorized user. The token device requires the presence of the biometric information from the authorized user to operate securely with the security system, using the biometric information to decrypt the aforementioned key for use in this security system. Thus, access will be granted only if the token is presented to the security system while the biometric information is presented to the token. An absence of either the token or the biometric information precludes access. In accordance with this invention, a copy of the biometric information is useless without the token, and the effects of a breach of security of both the biometric information and token can be minimized by invalidating the breached token.

### BACKGROUND OF THE INVENTION

1. Field of the Invention

This invention relates to the field of security systems and in particular to authentication and access security using biometric information.

2. Description of Related Art

Biometric information, such as fingerprints, retina patterns, voice prints and the like, is often used to uniquely identify individuals. As illustrated in FIG. 1, electronic access systems 100 are available that read 110 the biometric data 101 from the individual, compare 140 the encoded biometric information 111 to a database 130 of the biometric information of authorized individuals, and grant access 150 only if a match 141 is found.

Biometrics based security systems are inherently more secure than other systems, because of the difficulty of falsifying, or forging, the biometric information. Biometric based security systems are also inherently easier to use, compared to systems that use identification cards and require the manual entry of a personal identification number (PIN). As technologies advance, for example, automatic teller machines (ATMs) will likely be outfitted with thumbprint pads that reads the thumbprint of the individual, and grant access to the individual's bank account based on a recognition of this thumbprint. Presumably, such devices will include means for distinguishing true biometric data 101 from artificial biometric data 101′, for example, from a plastic reproduction of the thumbprint. Alternatively, the ATMs will be configured with retinal scan devices, because the forging of a retina pattern is inherently more difficult, the biometric data being more difficult to acquire.

Unfortunately, the characteristics of biometric information that provide advantages to biometric based security systems are also the characteristics that make the use of biometric based security systems particularly problematic. Consider, for example, the use of the aforementioned electronic fingerprint reading device. To be commercially successful, these devices must be able to read and encode a fingerprint quickly and reliably. Their ability to capture the fingerprint information quickly will be particularly attractive to a villain who wants to surreptitiously collect this biometric information. Such a villain, for example, may replace an elevator call button with a fingerprint collection device 115 to collect 120 the fingerprints of every person, or select persons, who use the elevator. Alternatively, the villain may copy the encoding of the biometric information by violating the security of the security device 100 and recording the encoded signals 111. Each communication of the individual's encoded biometric information 111 increases the likelihood of a villain gaining access to this information. Armed with a recorded encoding 120 of an another individual's fingerprint, the villain may violate the physical security of the security device 100, interject the encoding of the other individual's fingerprint at 111′, and gain an unauthorized access. Although this unauthorized access may require a breach of the physical security device 100, it does not require a physical intrusion to the individual's security, such as a theft of the individual's credit card, and hence may be less immediately detectable.

Consider now the difficulties incurred because of the other attributes of biometric information: uniqueness and immutability. The fingerprints of an individual are unique to that individual and cannot be changed. When an individual's credit card is stolen, the individual merely cancels the stolen card and obtains a new one; when an individual's PIN is compromised, the individual merely chooses another number. A loss may be incurred by the initial unauthorized access, but future losses are eliminated by invalidating the breached information. The information is invalidated by declaring the credit card or PIN as compromised to the securing authority and precluding further authorizations based on that credit card or PIN. When an individual's biometric information is stolen, however, the individual cannot effect a remedy. The only option the individual and the securing authority have is to invalidate the biometric information by declaring the biometric information as compromised, and prohibiting the use of this individual's biometric information for access control. Each individual whose biometric information has been compromised will be forced to revert to the more conventional means of identification, such as cards and PINs. That is, once villains develop means for breaching biometric security systems by copying the biometric information, the use of biometric information for secure access or authentication will become increasingly more impractical.

### BRIEF SUMMARY OF THE INVENTION

It is an object of this invention to provide a biometric authentication and access security method that is less susceptible to forged or copied biometric information. It is a further object of this invention to minimize the communication of biometric information. It is a further object of this invention to provide a means of invalidating the use of biometric information in the event of a breach in the security of this biometric information without invalidating the biometric information itself.

These objects and others are achieved by providing a token device that is used in conjunction with an individual's biometric information for authentication and access security. The token device contains a key that is encrypted using the user's biometric information. The security system communicates with the token device using a secure challenge-response scenario. The device requires the presence of the biometric information from the individual to operate securely with the security system, using the biometric information to decrypt the aforementioned key for use in this security system. Thus, access will be granted only if the token is presented to the security system while the biometric information is presented to the token. An absence of either the token or the biometric information precludes access.

In addition to the increased security provided by requiring both the biometric information and the token, the security system in accordance with this invention does not communicate the biometric information to the security system. Furthermore, in accordance with this invention, a copy of the biometric information is useless without the token, and the effects of a breach of security of both the biometric information and token can be minimized by merely invalidating the breached token.

### BRIEF DESCRIPTION OF THE DRAWINGS

FIG. 1 illustrates an example block diagram of a prior art access security system.

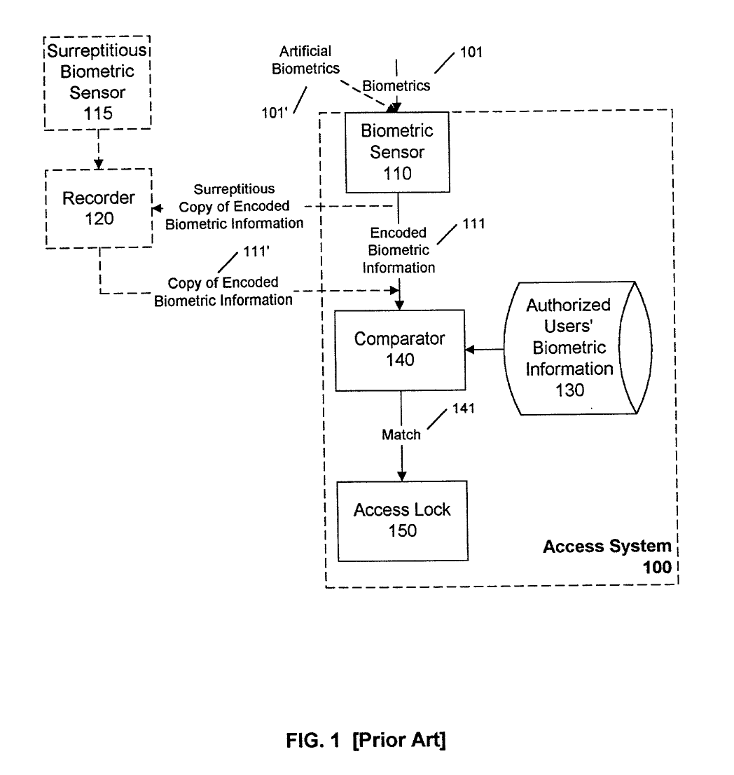

FIG. 2 illustrates an example block diagram of an access security system in accordance with this invention.

FIG. 3 illustrates an example flow diagram for initializing a token with an encryption of a private key in accordance with this invention.

FIG. 4 illustrates an example flow diagram of an access security system in accordance with this invention.

### DETAILED DESCRIPTION OF THE INVENTION

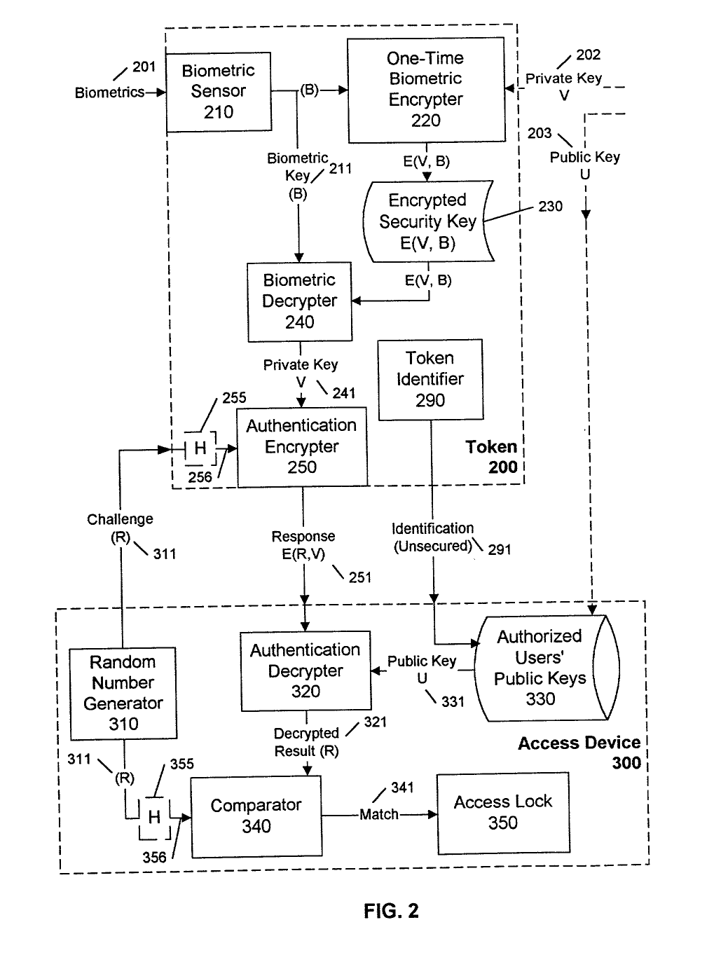

FIG. 2 illustrates an example block diagram of an access security system in accordance with this invention. The term access is used herein in the most general sense, including access to places, objects, and information, as well as the authentication of an individual for recording purposes, such as an entry in a log. The security system comprises a security token 200 that is carried by the individual, and an access device 300 that interacts with the token 200 to authenticate the individual as an authorized user.

The example access device 300 of FIG. 2 is a conventional challenge-response authentication device. In this example, the access device 300 uses an asymmetric, dual key (public/private), encryption system. As is common in the art, in a dual key system, data that is encrypted using one key of the pair of keys can be decrypted by the other key of the pair. For convenience, the letters U and V are used herein to identify the pUblic and priVate keys of a dual key pair, respectively. The example access device 300 comprises a random number generator 310, an authentication decrypter 320, a set 330 of authorized users' public keys, a comparator 340, and an access lock 350. The access device 300 communicates a random number R 311 as a challenge, and receives in response to this challenge, an encryption E(R, V) 251 of the random number R 311. The encryption E(R, V) 251 of the random number R 311 is an encryption based on a key V 241. As will be discussed below, if the authorized user is the current user of the token, the key V 241 will be the private key of the authorized user. The authentication decrypter 320 decrypts the encryption E(R, V) 251 of the random number R 311 using the authorized user's public key U 331. If the decrypted result D(E(R, V), U) 321 is identical to the random number R 311 that was communicated to the token 200, a match 341 is asserted and access 250 is granted. That is, access is granted only if the random number R 311 is encrypted using an authorized user's private key V corresponding to a public key U at the access device 300.

Illustrated in FIG. 2 are optional hash devices H 255, 355 for additional security. Rather than directly encrypting the random number R 311, the authentication encrypter 250 encrypts a hashed encoding H(R) 256 of the random number R311 from the hash device 255. In this optional embodiment, the authentication encrypter 250 communicates the encrypted response E(H(R),V) 251 to the access device 300. In like manner, the hash device 355 provides a hashed encoding H(R) 356 of the random number R 311 to the comparator 340, using the same hashing function H. The comparator 340 compares the hashed encoding H(R) 356 to the decrypted result D(E(H(R), V), U) 321 to determine the access status based on the match 341 of these hash encodings 356, 321. Access is granted only if the hash encodings 356, 321 match. For clarity and ease of understanding, the subsequent detailed description reference the encryption and decryption of the random number R 311 directed, rather than via the aforementioned optional hashed encodings 256, 356 of the random number R 311. The appropriate substitutions of the hashed encodings 256, 356 for the random number R 311 will be evident to one of ordinary skill in the art, based on the above detailed description of the implementation of the device using the optional hash devices 255, 355.

In accordance with this invention, the authorized user's private key V 241 is stored in the token 200 in an encrypted form 230. The encryption E(V, B) 230 of the authorized user's private key V is based upon a biometric encryption key B 211 corresponding to the authorized user. The example token 200 includes a biometric sensor 210, a one-time biometric encrypter 220, a storage 230, a biometric decrypter 240, and an authentication encrypter 250. The token 200 also includes an optional token identifier 290.

In the example token 200 of FIG. 2, the encrypted key E(V, B) is symmetrically encrypted, wherein the same key B 211 is used to encrypt and decrypt the key V. When the token 200 is first issued to the authorized user, the authorized user's private key V 202 is entered into the one-time biometric encrypter 220 while the authorized user provides the biometric data 201 to the token 200, for example by holding it with a finger on the biometric sensor 210. The terms biometric encrypter and biometric decrypter are used herein to distinguish the encrypter 220 from other encrypters and decrypters in the invention; the adjective biometric merely indicates the source of the key that is used for the encryption or decryption. The one-time biometric encrypter 220 uses the encoded biometric key B 211 of the authorized user from the biometric sensor 210 to encode the user's private key V 202, and this encrypted key E(V, B) is stored in the storage 230. In a preferred embodiment, the user's private key V 202 is destroyed immediately after it is encrypted.

The authorized user's public key U 203 corresponding to this private key V 202 is stored in the authorized users' public key database 330 at the access device 300. In a preferred embodiment, the access device 300 contains safeguards to assure that only authorized user's public keys are entered into this data base 330. For example, if the authorized user public key is communicated from a remote location to the access device 300, certification systems common in the art are employed to accept only those keys that are digitally signed by an authorizing authority. Associated with the public key U is an identification of the user, or an identification of the token 200, or both. For example, for access to an ATM, the public key U is associated with the particular user's bank account number, or the user's social security number, or some other data that identifies the user. To alleviate the necessity of the user providing this identification via a separate process, the example token 200 contains a token identifier 290 that identifies the user or the user's token to the access device 300. The identification 291 provided by the token identifier 290 may be the user's bank account number, the user's social security number, or another number that is associated with the user in the database 330.

The biometric sensor 210 transforms the biometrics measure 201 of the current user of the token 200 into an encoded form B 211 that is suitable for use as a symmetric key for encrypting the private key V 202. As is known in the art of cryptography, some forms of information are preferable to others for encryption, and techniques are commonly available for transforming information from an original form to a preferred form for use as an encryption key. In the preferred embodiment, a hashing function is used to generate the biometric key B 211 for a common encryption algorithm, such as DES or triple-DES, and the like. In the preferred embodiment, the biometric key B 211 has the characteristics such that it is the only key that will provide a decrypted key V 241 that is identical to the private key V 202 from the stored encryption E(V, B). If a hashing function is used, the biometric key B 211 also has the desirable characteristic that it is virtually impossible to derive the original biometric data 201 from the key B 211. Note that the biometric encrypter 220 need not reside in the token 200; it could be an external encrypter that receives the biometric key B from the biometric sensor 210 or a different biometric sensor 210′ and provides the encrypted key E(V, B) to the token 200 for storage 230.

When the user desires access via the access device 300, the user presents the token 200 to the access device 300 for the challenge-response procedure described above. The user whose biometrics 201 formed the encryption key B 211 that was used to encrypt the private key V 202 is termed herein as the authorized user of the token 200. When the authorized user provides the biometrics 201 to the biometric sensor 210, for example by placing a finger on a fingerprint sensor, the biometric decrypter 240 decrypts the encrypted private key E(V, B) 230 and produces the private key V 241. When the authorized user operates the token 200 in the presence of the access device 300, the authentication encrypter 250 encrypts the challenge random number R 311 using the private key V 241 that corresponds to the public key U 331 that is stored in the authorized users' public keys database 330. The decrypter 320 in the access device 300 decrypts the response E(R, V) 251 from the encrypter 250 in the token 200 and produces therefrom the decrypted result R 321. The decrypted result R 321 matches the original random number R 311 only if the response E(R, V) 251 is encrypted using the private key V 241 that corresponds to the public key U 331 of the authorized user. If the decrypted result R 321 matches the random number R 311, access is granted.

Note that if different biometrics 201 are provided, for example by another person, the decrypted key 241 will not be the encrypted private key V, and the decrypted result 321 will not be the original random number R 311 and access will not be granted. Note also that the biometric information is neither stored nor communicated by the token 200. To gain access, a villain must steal the token 200 and must also forge either the biometrics 201 or the biometric encryption key 211. To hinder this activity, in a preferred embodiment, the token 200 is constructed such that access to the internals of the token 200 destroys the encrypted key 230 and all forms of the biometric data. As is common in the art, physical or electrical means may be used to destroy the contents of the token 200. The electronic erasure means include, for example, the use of fusible links in the storage 230, volatile memory elements, and the like. Physical security means include, for example, acid that is released when the encapsulation of the token 200 is broken.

Upon discovery of a breach of security, for example a mysterious disappearance of the token 200, the token 200 can be invalidated by a mere removal of the public key U 331 from the database of authorized users' public keys 330. A new token 200′ can then be issued to the user, using a new pair of keys U′, V′. Thereafter, only the new token 200′ that contains the encrypted key E(V′, B) will be usable to gain access to the access device 300 that contains the public key U′, provided that the new token 200′ is provided the appropriate biometrics 201 at the time of access to generate the proper biometric key B 211. Thus, as shown, in accordance with this invention, the use of biometrics information (via a stolen token 200) can be invalidated without invalidating the biometric information (201, B 211) itself.

The token 200 may be implemented in a variety of forms. For example, a fingerprint token may be formed as a handheld device having a thumbprint sensor that is activated by the user by placing a thumb on the sensor while aiming the token at the access device, akin to a garage door opener or other types of remote controls. Similarly, it could be in the form of an ID card with a fingerprint sensor and a transducer. A retina scan token may be formed as a monocle which the user places on an eye while facing the access device. A voice print token may be formed as a microphone. As technologies advance, such tokens may be embedded under the user's skin, using for example, the user's DNA as the biometrics data. These and other embodiments of this invention will be evident to one of ordinary skill in the art.

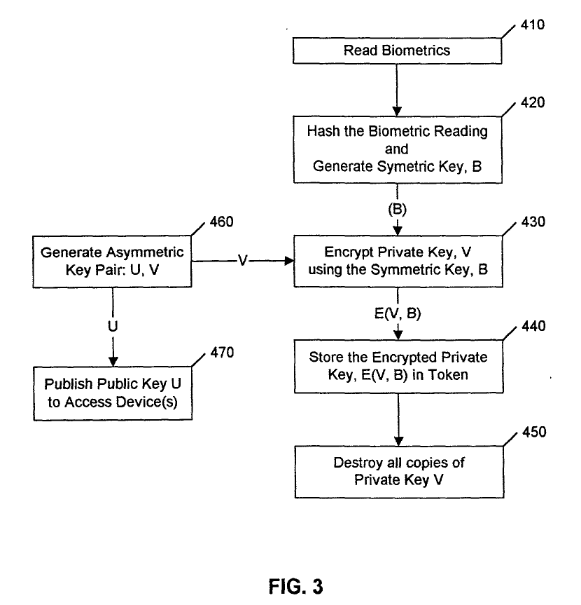

FIG. 3 illustrates an example flow diagram for initializing the token with an encryption of a private key V in accordance with this invention. The biometric data is read at 410, using for example, a fingerprint pad, a retina scan, a voice print, and so on. Techniques and devices are common in the art for the collection and processing of biometric input to produce consistent and repeatable biometric data corresponding to an individual user. Illustrated in FIG. 3 is the optional hash encoding that is used to generate the biometric key B, at 420, from the encoded biometric information. In general, a biometric reader will have a resolution which is specified in terms of the number of bits in the encoding. Similarly, the encryption process at 430 will have a key size which is specified in terms of the number of bits in the key. The number of bits in the key determines the level of security provided, because the difficulty of breaching the security of a code is exponentially dependent on the number of bits in the key. Preferably, the biometric information contains a sufficient resolution to generate at least as many bits as the number of bits in the encryption key. The hashing and key generation function of block 420 effects a transformation from the number of bits in the biometric information into the appropriate number of bits in the key. Optionally, if the preferred hashing function is not implemented, the block 420 provides the appropriate number of bits for the key by truncating or replicating the bits in the biometric information. That is, for example, if the biometric sensor produces 64 bits of biometric information and the encryption key is 56 bits, eight bits are truncated from the biometric information. If there is a significance to the bits in the biometric information, those of least significance, i.e. least information content, are selected as the bits to be truncated. Similarly, if the biometric sensor produces 40 bits and the encryption key is 56 bits, sixteen of the bits of the biometric information are replicated to produce the required 56 bits for the biometric encryption key B, or sixteen bits of the key B are set to a predetermined value.

Independently, a dual key pair U, V is generated, at 460. This generation can be via any number of existing algorithms for generating asymmetric public/private encryption keys. The private key V is encrypted using the biometric key B, at 430. The encryption of the private key V, based on the biometric key B, E(V, B), is stored in the token, at 440. The public key U corresponding to the encrypted private key V, is published to any and all security devices that are intended to be used by the user via the token containing the encrypted key V, at 470. For security purposes, the private key V and all copies of it should be destroyed, as indicated by block 450.

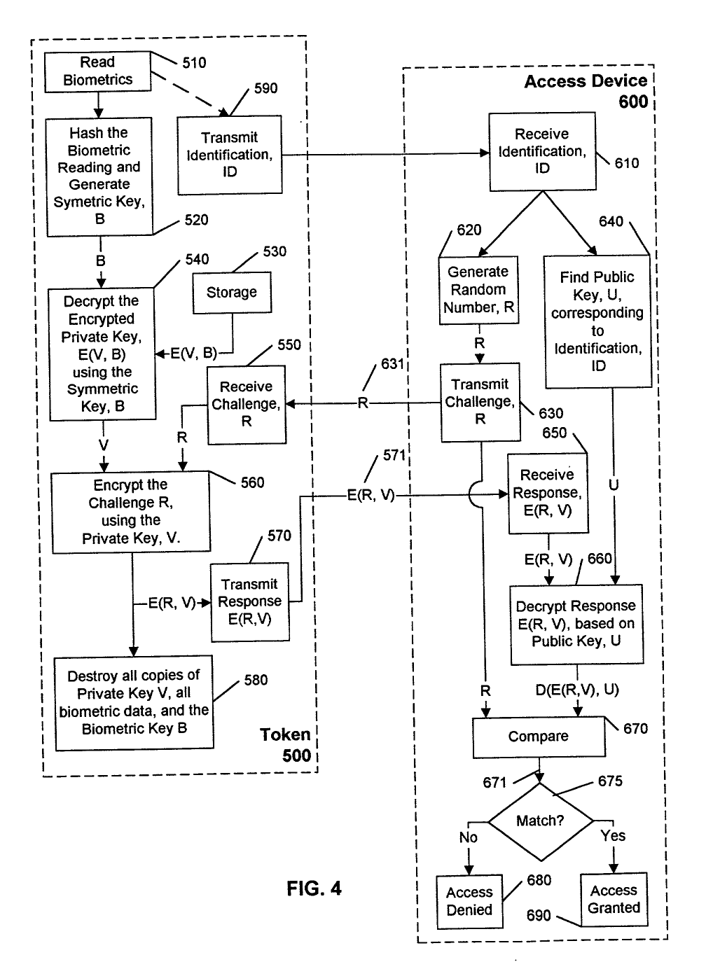

FIG. 4 illustrates an example flow diagram for an access security system in accordance with this invention. The access security system of FIG. 4 includes a token 500 and an access device 600. The blocks 510 and 520 perform identical functions to blocks 410 and 420, discussed above. Different numerals are used in FIG. 4 compared to FIG. 2 in order to expressly illustrate that the encryption of the private key V as illustrated in FIG. 4 may use different components than those used in the token 200, provided that the components perform the same transformation of the user's biometric measure into the same biometric key B. For ease of reference, the user at this point in time will be referred to herein as the current user, because it is unknown whether this user is the authorized user or a villain who has stolen the token. When the current user of the token 500 is the authorized user, the biometric key B is generated by blocks 510 and 520; when the current user is not the authorized user, a different biometric key B′ is generated by blocks 510 and 520. Block 530 represents the aforementioned storage of the encrypted private key E(V, B) of the authorized user. The encrypted private key E(V, B) is decrypted by the biometric key B to produce the private key V, at 540. If a different biometric key B′ is used, a different key V′ will be produced at 540.

When the access device 600 transmits a challenge R 631, discussed below, the token 500 receives it, at 550, and provides it to the encryption block 560. The encryption block 560 encrypts the challenge R 631 using the key V (or V′) and block 570 transmits the encryption E(R, V) or E(R, V′) 571 to the access device 600. For security purposes, block 580 calls for the express destruction of all copies of the private key V and all data related to the biometrics. This destruction can be effected, for example, by expressly clearing any registers that had held the biometrics that were read at 510, the hashed symmetric key B at 520, the private key V at 540, and so on.

The access device 600 receives an identification ID of a user, at 610. This identification may be entered, for example, by the user presenting a bank card to an ATM machine. In the preferred embodiment, the identification is provided by the token 500, at block 590, thereby eliminating the need for the user to carry both an identification card and a token. Upon receipt of a user identification, the access device 600 initiates the challenge-response protocol by generating a random number, at 620, and transmits it to the token 500 as challenge R 631, at 630. The receipt of the user identification ID at 610 also initiates a search of a database of authorized users for the public key U that is associated with the identified user. If the user identification ID does not have a corresponding public key U, block 540 produces a null key U′.

In response to the challenge R, the token 500 returns an encryption of the challenge R. This encryption will be either E(R, V), the encryption based on the proper private key V, or E(R, V′), an encryption based on an erroneous key V′, as would be produced by a different person's biometric key B′ at 560. The encrypted response E(R, V) or E(R, V′) is received at block 650 and provided to the decryption block 660. The decryption block 660 applies the user's public key U to the encrypted response E(R, V) or E(R, V′). If the former encrypted response E(R, V) is received, the decryption block 660 will produce a decrypted result D(E(R, V), U) that is equal to the original challenge R 631. If the latter encrypted response E(R, V′) is received, the decryption block 660 will produce a result D(E(R, V′),U) that does not equal the original challenge R 631. At 670, the decrypted result D(E(R, V),U) or D(E(R, V′),U) is compared with the original challenge R 631 to determine an access status 671. If, at 675, the decrypted result matches the original challenge, access is granted at 690; if the decrypted result does not match the original challenge, access is denied at 680. Note that a non-match will also occur if an improper user key U′ is provided by the block 640, for example in response to an incorrect user identification at 610.

Thus, as can be seen by the example flow diagram of FIG. 4, access will only be granted if the biometric key B matches the original biometric key that was used to encrypt the private key V, and only if the private key V corresponds to the public key U that is stored at the access device. If the security of the system is breached, subsequent access can be denied by merely removing the public key U from the database of authorized users. Subsequent authorized access can be effected by providing a new set of public/private passwords and repeating the process of FIG. 3.

As presented thus far, the preferred embodiment of the invention includes high-security public/private asymmetric keys and a challenge-response security protocol. As would be evident to one of ordinary skill in the art, less complex methods may be used, albeit with an accompanying decrease in the level of security provided. For example, the token may merely contain an encryption of a user's PIN, and may be structured to decrypt and communicate this PIN to the access device directly. That is, for example, such a token would replace the need for the user to type in the PIN at a conventional ATM machine that is modified to accept the transmission of the PIN from the token. Such a token would not provide the same level of security as the preferred dual key embodiment, but it may be more secure than the current keypad method, because it eliminates the possibility of a villain determining the PIN by observing the user's keystrokes. Other security measures, between these example low-security and high-security embodiments would be evident to one of ordinary skill in the art.

The foregoing merely illustrates the principles of the invention. It will thus be appreciated that those skilled in the art will be able to devise various arrangements which, although not explicitly described or shown herein, embody the principles of the invention and are thus within its spirit and scope. For example, rather than providing an identification of the user or the token to the access device 300 via 291, the access device 300 can effect an exhaustive search of the authorized users' public keys database 330 to determine whether any of the public keys U in the database 330 effects a decryption of the original random number R 311. If so, access is granted, with or without an explicit identification of which authorized user is present. Similarly, a pair of keys U, V can be associated with a group of users, rather than each individual user. In this example, each user in the group will have a token that contains an encryption of the same private key V, but each encryption will be based on each user's biometric information. Also, the biometric information need not be unique to each user. For example, the biometric information may merely be a blood type, and anyone that has that blood type can use the same token. Such tokens may be used, for example, to prevent mistaken transfusions. Or, for example, such tokens may be used to grant or deny access based on other characteristics such as gender, age, and the like.

The particular embodiments discussed herein are presented for illustration purposes only. As would be evident to one of ordinary skill in the art, the individual components of the token 200 and access device 300 may be implemented in hardware, software, or a combination of both. The partitioning and placement of functional blocks within the token 200 and access device 300 can be adjusted as required or as desired. For example, the database of authorized users' public keys need not be located with the access device 300. The database may be located on the World Wide Web, and the decrypter 320 retrieves the user public key U via a web page access. As with the entry of data into the database of authorized user public keys, in the preferred embodiment the communication of authorized user public keys will also be authenticated via certification systems common in the art. The access lock 350 may be remotely located, or absent completely. For example, the access device 300 may be a device at a guard station, wherein the match 341 provides an access status that is merely indicated by a green light for the guard's perusal. Other uses of this invention will also be evident to one of ordinary skill in the art. For example, the token 200 may also include a location identifier, such as a GPS device, and the access system 300 is used to track the location of each individual. By requiring a combination of the token 200 and the biometrics from the user, an attempt to avoid tracking by discarding the token 200 will be immediately detectable by a non-match from the comparator 340. In like manner, a combination of tokens, such as a guard token whenever a prisoner token is present in an area, may be used to indicate a security status.

I claim:

1. A security token comprising:
a biometric sensor that provides a first biometric key of a current user of the security token, based upon a biometric measure of the current user,
a storage element that stores an encryption) of a security key, the encryption) being based on a second biometric key of an authorized user, and
a biometric decrypter, operably coupled to the biometric sensor and the storage element, that decrypts the encryption) of the security key, producing thereby a decrypted security key that is equal to the security key when the first biometric key is equivalent to the second biometric key.

2. The security token of claim 1, further including:
an authentication encrypter, operably coupled to the biometric decrypter, that encrypts a challenge parameter to produce a response parameter that is based upon the decrypted security key.

3. The security token of claim 2, further including:
a token identifier that provides an identification that is associated with the authorized user.

4. The security token of claim 1, further including:
a token identifier that provides an identification that is associated with the authorized user.

5. The security token of claim 1, wherein
the biometric sensor provides the first biometric key based upon a hash of the biometric measure of the current user.

6. The security token of claim 1, wherein
the second biometric key is a symmetric key.

7. The security token of claim 8, wherein
the security key is a private key of a set of asymmetric keys that include at least one private key and at least one public key.

8. The security token of claim 1, further including
a one-time encrypter that produces the encryption) of the security key based upon the second biometric key.

9. A security system comprising:
a token that includes:
a biometric sensor that provides a first biometric key of a current user of the token based upon a biometric measure of the current user,
an encryption) of a security key, the encryption) being based upon a second biometric key of an authorized user, and
a biometric decrypter that decrypts the encryption) of the security key to produce a decrypted security key, such that
the decrypted security key is equivalent to the security key when the first biometric key is equivalent to the second biometric key, and
the decrypted security key is an erroneous key when the first biometric key is different from the second biometric key; and
an access device that, when operably coupled to the token, determines an access status based upon the decrypted security key.

10. The security system of claim 9, wherein
the access status is a verification that the current user is the authorized user.

11. The security system of claim 9, wherein the access device includes:
a challenge device that provides a challenge parameter to the token, and
a receiving device that receives a response parameter from the token based upon the challenge parameter and the decrypted security key;
wherein the access status is based upon the response parameter.

12. The security system of claim 11, wherein the token further includes:
an authentication encrypter that encrypts the challenge parameter to produce the response parameter, the encryption) being based upon the decrypted security key.

13. The security system of claim 12, wherein:
the security key is a first key of a pair of asymmetric keys, and the receiving device includes:
an authentication decrypter that decrypts the response parameter to produce a decrypted result, the decryption being based upon a second key of the pair of asymmetric keys, and
a comparator that compares the decrypted result with the challenge parameter to determine the access status.

14. The security system of claim 13, further including
a database of authorized user keys from which the second key of the pair of asymmetric keys corresponding to the authorized user is determined.

15. The security system of claim 14, wherein
the token further includes a token identifier that provides an identification corresponding to the authorized user, and
the determination of the second key of the pair of asymmetric keys from the database of authorized user keys is based upon the identification corresponding to the authorized user.

16. The security system of claim 11, wherein the token further includes:
an encapsulation that obstructs access to components of the token, and
a means for destroying at least one of the second biometric key and the encryption) of the security key when the encapsulation is breached.

17. The security system of claim 11, wherein the access device further includes
a random number generator to facilitate the determination of the access status based upon the decrypted security key.

18. A method for determining an access status comprising the steps of:
encrypting a security key to produce an encrypted security key) based upon a first biometric key of an authorized user into a token,
determining a second biometric key of a current user of the token based upon a biometric measure of the current user,
decrypting the encrypted security key) to produce a decrypted security key based upon the second biometric measure, and
determining an access status based upon the decrypted security key.

19. The method of claim 18, further including the steps of:
communicating a challenge parameter to the token, and
determining a response parameter based upon the challenge parameter and the second biometric key; and
wherein the step of determining the access status is based upon the response parameter.

20. The method of claim 19, wherein
the security key is a first key of a pair of asymmetric keys,
the step of determining the response parameter includes the step of encrypting the challenge parameter based upon the second biometric key,
the step of determining the access status includes the steps of:
decrypting the response parameter to produce a decrypted result based upon a second key of the pair of asymmetric keys, and
comparing the decrypted result to the challenge parameter to determine the access status.
